(19) United States
(12) Patent Application Publication
(10) Pub. No.: US 2007/0120301 A1
(43) Pub. Date: May 31, 2007

(54) Multi-storage isolator with conical cross section

(75) Inventors: Daniel R. Domen, Rochester Hills, MI (US); Peter Jing-Lug Chen, Rochester, MI (US); Mohammed Ansari, Rochester Hills, MI (US)

Correspondence Address: Valeo, Inc.;Intellectual Property Department, 4100 North Atlantic Boulevard, Auburn Hills, MI, 48326, US

(73) Assignee: Valeo, Inc., Auburn Hills, MI (US)

(21) Appl. No.: 11/604,501

(22) Filed: Nov. 27, 2006

Related U.S. Application Data
(60) Provisional application No. 60/740,767, filed on Nov. 30, 2005.

(51) Int. Cl. F16F 3/08

(52) U.S. Cl. 267/152; 267/153

(57) ABSTRACT

Isolator assemblies and isolators between separate parts or components, and, particularly, multi stage isolators, especially, isolators useful in automotive applications are described. The isolators have a conical cross section, made of the same material as the isolator body, which can flex when in a deflection stage, or can compress in a compression stage, thus allowing for reduced vibration transmission and/or wear or longer life for both the isolator and the parts and components separated thereby.

### FIELD OF THE INVENTION

The present invention relates to isolators, and, in particular, isolators useful in automotive applications, to reduce undesirable contact or impact, and/or its associated noise, between various parts or components of the automotive vehicle.

### BACKGROUND OF THE INVENTION

Isolators are useful in a number of applications, especially where vibration or other movement might occur between two devices, parts or portions of devices or parts. Such vibration or movement can cause both contact issues as well as noise issues related to undesired contact or impact. Particularly in assemblies where devices or parts must be mounted together or in close proximity to one another, undesirable contact may occur, and isolators have, as one of their functions, the function of preventing or modulating undesirable contact in such a manner that it either becomes a non-harmful contact, or even an advantageous one.

Isolation can occur in numerous stages or steps. Multi-stage isolation can be achieved in the same isolator or isolator pad by over-molding different density materials or by thinning specific webs called ‘thinning webs’ between mounting surfaces.

Isolators can be made from elastic material, and, thus, can have levels of stiffness. Isolators may also be made via various processes.

Isolators have been found to be particularly useful in automotive applications. One such application is that of heat exchanger assembles, particularly where such assemblies are mounted to vehicles, and, in particular, automotive vehicles. In such automotive applications, heat exchanger assemblies are often mounted either as a single unit or as a group in, for example, a cooling module assembly.

In general automotive applications, vibration and other movements are felt throughout various areas of the automobile, particularly when the automobile is moving in the lateral or vertical sense. Otherwise stated, a motor vehicle, when either moving forward or backward, or when being transported in numerous directions, or even when idling with the motor operation, is subject to movement that may cause various parts or components of the automobile to contact one another. A heat exchanger assembly, and/or its component/parts, may contact or collide with other parts, components or portions of other assemblies or the frame of the automobile, and lead to potential damage, to either the heat exchanger, the heat exchanger assembly, or other parts of the vehicle itself. In the case of heat exchangers, for example, materials can account for more than half of the total cost of the exchanger. Such exchangers are, therefore, being made of materials that are of the minimal thickness possible—however, such thin metal and plastic materials often cannot withstand the impact stress which occurs through a motorized vehicle frame that occurs while driving on rough roads or making sudden stops or sharp turns. Isolators, correctly designed, reduce potential damage to the heat exchanger assembly under impact or contact stress conditions.

In any system where movement may cause undesired impact or contact between parts or devices, three elements are often considered. For example, in heat exchanger mounting and isolation systems, vibration issues, such as Noise, Vibration & Harshness (NVH), occur. This movement can be described as “low excursion/high frequency” vibration that produces “airborne sound”. This movement can be described as medium inertia/medium frequency vibration. If the mounting has a relatively stiff vehicle component, it can receive and transmit vibrations that can annoy the quiet and comfort of the passengers in and around the vehicle. This movement can be described as ‘high inertia/low frequency impact’ often associated with “rough road” driving conditions. For example, severe differences could occur under conditions such as driving across a shallow hole or sharp turning of a vehicle at sufficient speed to cause damage to the heat exchanger assemblies. In such systems, one of the isolator's purposes is to allow for an attachment that is not too rigid, or even what might be called a ‘loose’ attachment of a heat exchanger assembly to a vehicle mounting frame. An isolator can also assist in dampening the differential movement between the heat exchangers and the vehicle, and thereby, help avoid undesired impact or contact between the heat exchanger assembly and the rest of the vehicle and/or its mounting or mounting frame.

Solutions to noise and vibration issues in various applications exist in the prior art. For example, soft isolators composed of lower durometer material (e.g. less than 30 durometer materials) have been used to eliminate noise transmission. One weakness is that thing can fail over time and are, more often than not, unable to absorb high impact energy such as that experienced while driving an automotive vehicle on unpaved or otherwise rough roads. Other solutions to noise issues, such as the use of vertical standing ribs, are described U.S. Pat. No. 5,960,673, issued Oct. 5, 1999, to Eaton et al., that can absorb initial noise transmission. However, this solution also has the disadvantage that the individual ribs can wear away prematurely because the high energy present is not adequately distributed over the full area of the isolator surface.

Stiff isolators, such as those described in U.S. Pat. Nos. 6,540,216 B2, issued Apr. 1, 2003, to Tousi et al. or U.S. Pat. No. 4,858,866, issued Aug. 22, 1989, to Werner, can absorb impact shock between components by keeping the components separated, but, both noise and vibration are more easily transmitted through the stiff rubber members. Webbed isolators, such as those described in U.S. Pat. No. 6,722,641, issued Apr. 20, 2004, to Yamada et al., are described as having various thicknesses of rubber webs and/or plastic or metal insert members, and rigidly support the mount in or on each side of the isolator mounting face. The isolator uses a different thickness of rubber web to vary its stiffness. With this solution, when parts move closer together relative to each other, resistance increases. However, this sort of assembly also generally costs more than other isolators or isolator systems. Loosely fitting isolators with, for example, an air gap at the mounting face, are shown in U.S. Pat. No. 6,540,216 B2 issued Apr. 1, 2003 to Tousi et al., wherein such isolators can be seen as useful in absorbing some misalignment of parts and/or undesirable vibration. However, such a gap can cause damaging impact from unrestricted acceleration across the gap when used between a heat exchanger and some adjacent components.

Dual density isolators, when using two different density materials for manufacture, are also known. Dual stage webbed isolators, for example, those using metal or plastic inserts, normally require separate placement of the inserts and lead to increased piece cost and mold cycle time, and can be too stiff and transmit too much vibration to be useful in many automotive applications.

The present invention addresses the problems of the prior art, especially related to undesired contact or impact scenarios found in assembly of parts in automotive applications.

Various aspects also addresse the fact that low durometer (stiffness) isolator material usually can not be used to achieve high durometer (stiffness) requirements due to wear and uneven isolator compression, and other such as designs considerations.

Isolators of various types are illustrated by two provisional applications filed Nov. 30, 2005, US patent application Ser. Nos. 60/740,784 and 60/740,983 Daniel Domen, Peter Chen and Mohammed Ansari, on which the present application claims priority and which are hereby incorporated by reference in their entireties.

### SUMMARY OF THE INVENTION

The present invention relates to isolator assemblies and isolators between separate parts or components, and, particularly, multi stage isolators, especially isolators useful in automotive applications.

In the automotive industry, heat exchange modules, such as cooling modules (modules assembled with the intention of using for heat transfer applications) may be assembled to the vehicle body, and, often, to the vehicle frame. For example, a mounting frame or a mounting frame vehicle component, an engine drive train component, a heat exchanger drive train component, or other components of an automobile vehicle are adjacent to one another, or otherwise contact one another, can be separated by use of isolators, in accordance with an aspect of the present invention.

Cooling modules, when assembled to the vehicle frame, are rarely if even in ‘perfect’ alignment. Each component or part of the module, and its fit, varies relative to the component or part next to it. The fit can be loose in many cases, or the components themselves can be grounded or snugly fit to each other through an isolator. Grounding transmits the vibration energy more or less in a direct manner to other components in the vehicle. Loose fitting assemblies can accelerate transfer of inappropriate energy, and, in particular, movement and later noise energy, during harsh driving conditions. Higher energy levels can damage both not only the cooling module, but also any adjacent components to either the module or the other parts of the automobile, or to the isolators between the cooling module and the adjacent components of the automobile.

The present invention, in preferred embodiments, reduces airborne noise by using an isolator of conical cross section, wherein the isolator wall or walls flex or bend to flat under increasing inertia load, and thereby ‘softly’ hold the oscillating or moving component or part and to slow the resonant movement or alter movement to a non-acoustic frequency. The conical walls are basically non-perpendicular to the load contact surfaces, and hollow areas formed between the walls and contact surfaces is evacuated as the walls, as the walls are flexed to flat they then enter a second stage called the compression phase.

Vibration is reduced by absorbing movement energy into the plastics elastomeric or rubber or rubber like component, thereby preventing vibrations to be passed on to subsequent components. Aspects of the present invention are useful to reduce, for example, severe impact of one component or part conical, using a cross section isolator with an adjacent component or part, that acts as a physical barrier or separator to slowing the acceleration of the parts toward each other. By absorbing the impact energy to a safe level, unwanted damage to either component or part is avoided.

The present invention in various aspects relates to isolator assemblies and isolators between separate parts or components, and, particularly, multi stage isolators, especially isolators useful in automotive applications. By dampening, or reducing the acceleration of a body as it travel from its initial point at rest towards its peak excursion at impact with a second body, isolator and isolator assemblies, in various aspects of the present invention, reduce wear and tear or all associated parts or components isolated by such isolators.

The present invention, in various aspects, allows for the production of “low cost” isolators that can be made from a single durometer material. The present invention, under conditions of load, provides for an isolator that can flex under light load and/or flatten, and, in aspects of the invention, flatten or be compressed to a uniform thickness, under heavier loading. The present invention, in various aspects, therefore, provides for an isolator of a single durometer material having a conical cross section, such that the isolator throughout is made of same material (and has the same stiffness), but can still go through at least two load resisting stages, depending on the loading due to contact (initial or light contact or impact ‘low inertia’).

Various aspects of the present invention comprise isolators that use one, two or more stages of isolation to result in decreased noise absorption and/or vibration and harshness to normally adjacent components that reduce life or endurance of components or parts, and especially heat exchanger components or parts. In other words, the present invention provides for applications that do not allow undesirable movement due to vibrations to be passed through an isolator or isolator portion, and, in particular, a solid compression isolator portion, preventing undesired movement from being passed on through other adjacent components. The aspects of the present invention provide, at lower cost, isolators that absorb high frequency noise vibration, medium vibration and low frequency/high inertia harsh vibration, without sacrificing overall endurance of the isolator. In addition, for example, a mounting frame or a mounting frame vehicle component, an engine drive train component, a heat exchanger drive train component, (or other components of an automobile vehicle are adjacent to one another, or otherwise might contact one another), can be separated by use of isolators, in accordance with an aspect of the present invention.

Aspects of the present invention provide for an isolator made from a single durometer material, such as a rubber or rubber-like material that can absorb lighter vibrations and also resist heavier impact load that it is made of. By allowing for an isolator of a generally uniform stiffness, position fits that may or may not be mis or mal aligned, while still providing for adequate dampening of noise and contact between parts exist. In particular aspects of the present invention, the isolator is a multi-stage isolator: particularly, the lighter loads tend to absorb vibrations in the first stage (the deflection stage). Higher impact type loads are absorbed in the second stage (the compression stage) and premature failure of the isolator cross section is reduced as the load is distributed over a larger contact area.

Multi-stage isolators may use different density materials. In embodiments of the present invention, different density materials are overmolded or specific material is thinned by thinning webs or the like between components or parts or vehicle the mounting surfaces. Various basic aspects of the present invention provide for an isolator comprising for an elastomeric, elastic, or rubber or rubber like material or materials. Though preferred embodiments of isolator are made of only one type of material, the isolator with conical cross section of aspect of the present invention can act like a multiple type or density isolator, due to its final uniform structure.

In various aspects of the present invention, an isolator has one or more, preferably two or more, portions shaped in approximately conical cross sections, to provide for a multi-stage type isolation. In other embodiments having conical cross section, the isolator may also have a slit or slit opening(s) that separate symmetrical portions of the conical cross section walls of the isolators.

In various aspects of the present invention, the conical shaped wall portion of the isolator is made of an approximate uniform thickness with the remainder of connecting walls so that when flattened to the compression phase, the wall is of an approximate uniform continuous thickness. When the conical wall portion is positioned between two opposing surfaces, the open hollow area at the base of the cone collapses under lighter loads to a flattened shape (fully collapsed cross section). The conical portion is able to deflect or ‘bend’ under this relatively low inertia load since the wall is being stressed in tension.

The fully deflected (flattened) walls remain in an approximately uniform thickness as the second stage of the multi-stage isolation effect ensues under continuing and/or heavier loads. The opposing surfaces of adjacent parts or components continue to exert an increased inertial load across the fully collapsed conical cross section. In isolators of the present invention, the shape and elastic properties of the conical cross section isolator, enters the second stage, the compression stage, and the contact surfaces of the components assemblies with isolators surfaces, disperse the load in a uniform fashion, across most, if not approximately all, of the fully flatted conical wall area. Stage two allows for the uniform distribution of energy across the isolator wall, thereby reducing the effect of localized higher energy at, for example, a thinned area such as a thinned web area.

In other embodiments of the present invention, the conical wall portion has one or more slits in the transverse direction across the conical wall. The slit or slits run in multiple directions; preferred are a slit or slits that run at least partially approximately normal to the radial direction of the conic wall. Where more then one slit is present, the slits preferably divide the walls into approximately equal portions, reducing the radial tension in the conical walls such that the load required to deflect the walls is reduced.

In other embodiments, a partial slit is used to separate the low to medium load first stage (deflection stage). In other embodiments, an approximately full length slit (slit which extends from the component contact surface to the connecting wall of the conical section) separates the one conical portion of the isolator from another conical portion undergoing the initial deflection stage from the portion of the isolator undergoing the second stage (compression stage).

Isolators with conical cross section also may comprise ribs, and, in particular, non-perpendicular ribs as related to the adjacent component contact surface to define a “soft contact” or loose positioning between parts, such as between a heat exchanger and a mounting frame of an automotive vehicle, is provided.

As used herein, a conical shape can also be a pyramidal shape wall section or any polygonal or polyhedral shape that forms an approximate like-shaped base cone base. Isolators with shapes with cone bases can also have slits that would tend to reduce the load required to deflect a specified distance.

The present invention, in various aspects, provides for a “low cost” isolator made from a single durometer material that flexes under light loading and flattens to a uniform thickness under heavier loading. The isolator may also have slits that divide the walls of a first stage ‘flexing’ portion which further enhances the initial flexibility and soften the initial deflection of the first stage.

### BRIEF DESCRIPTION OF THE FIGURES

FIG. 1 illustrates a heat exchanger Isolators in housing & frame assembly, with upper sleeved isolator & lower pin isolator, in accordance with an aspect of the present invention.

FIG. 2 illustrates a prior art round solid isolator, having a single stage dampening.

FIG. 3 illustrates a round convex conic isolator having dual stage dampening, in accordance with an aspect of the present invention.

FIG. 4 illustrates a round concave conic isolator having an anti-compression sleeve, in accordance with an aspect of the present invention.

FIG. 5 illustrates a square concave pyramid isolator having anti-compression sleeve, in accordance with an aspect of the present invention.

FIG. 6 illustrates a square concave pyramid with slits isolator, in accordance with an aspect of the present invention.

FIG. 7 illustrates a round convex conic isolator with dual conic attributes, in accordance with an aspect of the present invention.

FIG. 8 illustrates a round concave conic isolator with dual conic attributes, in accordance with an aspect of the present invention.

FIG. 9 illustrates a single sided convex “D” shaped conical/pyramidal pin isolator with contoured lower edge, in accordance with an aspect of the present invention.

FIG. 10 illustrates a (prior art) round single stage pin isolator.

FIG. 11 illustrates a round convex conic pin isolator with wiper ribs at pin surface, in accordance with an aspect of the present invention.

FIG. 12 illustrates a round concave conic pin isolator, in accordance with an aspect of the present invention.

FIG. 13 illustrates a round double concave conic pin isolator with wedge cut-out in accordance with an aspect of the present invention.

FIG. 14 illustrates a round convex conic pin isolator with wiper ribs & slit apertures in free state assembly, in accordance with an aspect of the present invention.

FIG. 15 illustrates a round convex conic pin isolator with wiper ribs & slit apertures, deflected as in assembly, in accordance with an aspect of the present invention.

FIG. 16 illustrates a concave/convex round elastic isolator comparison chart, in accordance with an aspect of the present invention.

### DETAILED DESCRIPTION OF THE PREFERRED EMBODIMENTS

In various aspects of the present invention, an isolator of a generally uniform stiffness for use between parts or components is described. The isolator is, preferably, made of a single durometer material, and has therefore behaves differently depending on the stage of load placed upon the isolator. The present invention, in preferred embodiments, provides for an isolator made of an elastic or elastomeric or rubber or rubber like material, having a conical cross section. Aspects of the present invention provide for a so called open ended ‘hollow’ in cross section. By example, an open ended cross section of an aspect of the present invention comprises an isolator having hollow polygonal portion open at one end of the isolator conic section and connecting wall, the walls around the hollow conical area. The hollow polygonal portion open at one end or the opening at the end of the hollow polygonal portion, is of a uniform wall thickness and the connecting isolator wall has portions shaped in approximately conical or pyramidal or a combination polygonal, polyhedral or the like, in cross section.

The thickness of the conic wall sections is approximately the thickness of the wall thickness which can isolate in at least two stages such as a deflecting stage and a compressing phase. As load is applied to the isolator of first wall section, when the deflects, until under lighter inertia load, it is to flat (a fully deflected wall). As load is further applied, a compression stage is entered when the rate of movement inward between the opposing component surfaces across the thickness of the isolator walls relative to increased load is increased dramatically.

The thickness of the polygonal wall section within the adjacent component contact area between a component adjacent and a mounting frame is approximately equal to the wall thickness of the remaining isolator connecting wall when the hollow is collapsed and the flattened wall section is aligned with the remaining connecting isolator wall.

The rate change that occurs in various aspects of the present invention, provide for high frequency/short excursion noise and vibration dampening during the first stage (in a flexing or deflection portion of the isolator). The second or compression stage involves the compression portion of the isolator as well, thereby providing a low frequency/high inertia dampening during harsh conditions.

In other aspects of the present invention, an isolator having a hollow, approximately conical cross section is illustrated. The isolator is such that it has a free standing height of approximately 1 to 3 times its normal conical portion wall thickness (conical portion wall vs. remaining connecting portion wall. The isolator has two portions, a deflecting portion and a compression portion. The compression portion is found at the narrow end of the conic section on the isolator. When the isolator is deflected until it reaches the second stage (compression stage); the wall thickness of the deflecting conical wall, forms an approximate uniform wall thickness remaining connecting wall for compression.

In measuring the effect of load on the deflection and compression stages on the isolators of preferred embodiments of the present invention, the general direction of load is applied approximately normal through the base of the symmetrical conic portion of the geometric cross section of conic cross section and along the central axis of the conic section. When an inertial force is applied against a contact surface of isolator, the conical section (or hollow portion of the isolator) deflects laterally outward at one rate as it elastically deforms and then as it goes flat between the opposing surfaces where the isolator section resists compression at an increased rate. The flattened isolator is, thereby, formed into a uniform thickness as it enters the compression stage which causing a change in the rate at which to components or parts, for example the opposing heat exchanger and mounting surfaces are allowed to move inward toward the isolator relative to the instantaneous inertial load.

The isolator deflecting portion, in various aspects, has an approximate central axis of the approximate conical shape having a wall thickness approximately equal to the normal wall when entering the compressive mode. This wall portion is preferably of a constant thickness. The initial conical shape, in preferred isolators of the present invention, is generally not perpendicular to the contact surfaces of the adjacent parts or components, to be isolated, for example, the surfaces of a heat exchanger assembly and the mounting frame contact surface that could potentially contact each other (contact surface) if no isolator is in place. The non perpendicular isolator wall section deflects laterally along the approaching contact surface of the adjacent component with increasing inertia load until it lays approximately flat and aligned with the remaining connecting wall to form an approximate uniform thickness between the opposite adjacent contact surfaces of the adjacent components separated by the uniform ageragate of isolator walls.

In further aspects of the present invention, an isolator with an open ended hollow conical cross section has walls that also have slit apertures axially positioned in the conical walls and separating the isolator into section in a general manner; preferably, the sections are equivalent to more or less symmetrical portions of the conical wall. Therefore, an isolator is slit apertures in its walls, may be divided into approximately equal wall portions of the conical and/polygonal portions of the isolators. The length of these slit apertures may run a portion of the length of the wall or the full length of the wall to tune the initial deflection. In such embodiments, the load deflection resistance rate to separate it from the compression mode resistance rate of the fully flattened wall. This allows further isolator tuning by increasing separation in the deflection and compression stages.

Further aspects of the present invention comprises one or more wiper ribs on the isolator that provide for a contact surfaces to allow a loose fit, to counter misalignment and twist, while also providing a soft contact to slow initial acceleration during periods of higher frequency vibrations. The non-perpendicular ribs walls relative to the adjacent component contact surface go flat to increase the isolator load area and equal the remaining connecting wall and assist in the prevention of one part moving against another. The nested ribs deflect into pockets of approximately equivalent volume to the rib along the wall surface, to provide for uniform load transmission throughout the isolator during the second or compression stages.

As described above, in various embodiments, an open ended hollow form can also be formed in a polygonal shape or a combination polygonal and conical shape. The conical cross section can be mirrored to form the shape of a double conical cross section so that the distance traveled is doubled for a specific load or that the for a specified deflection distance the load is approximately one-half (½) the load.

In preferred embodiments of the present invention, the isolator is made of a single material, most preferably of a single durometer stiffness, formed in a geometric shape. The preferred shape allows for a constant wall thickness such that the wall can be deflected at a first rate, during the first or deflection stage and to be formed to an approximately flat configuration where the total the individual wall thicknesses approximate the normal wall thickness, at second rate during the second or compression stage at a uniform compression load increases for a given deflection of the single, and, preferably, elastic, elastomeric, rubber or rubber like material. The geometric shape change of the isolator provides at least two separate load stages to meet the different misalignment, noise, and vibration and harshness conditions, as well as having wall configurations the increase wall area to distribute the load at high inertia harshness conditions. Nesting the geometric shapes to form a uniform wall additionally minimizes the local stress on the thin wall areas of conical and connecting wall portions of the isolator to leading to increase durability of the isolator or assembly using such as isolator.

The isolators of the present invention are preferably of an elastic or elastomeric material, such as elastomeric polymers or resins or rubber, or such types of materials with elastic properties that are capable of being, preferably is molded of a single durometer stiffness material.

A rib, and, in particular a wiper rib, of the approximate same durometer can, in various aspects of the present invention used in conjunction with the conical cross section of the isolator.

In various aspects of the present invention, an isolator is formed having shapes with hollow areas opened at one end of each polygonal form that can deflect geometrically to flat so that it can have several stages of isolation. The walls around the hollow areas experience a deflecting stage where the rubber or other wall around the geometric hollow areas, and bend inward to close the hollow, thus allowing for suspension of a part or components, such as, a heat exchanger component, relative to a part or component (such as a mounting frame of a vehicle), and the absorption of vibration generated by differential movement between the heat exchanger assembly and the mounting frame is reduced. The wall thicknesses around the hollow area are to be approximately the same thickness as the fully flattened wall when deflected to the initial compression stage.

A preferred embodiment of an isolator in accordance with the present invention has a hollow conical portion open at the conical base end, and is of a convex shape away from the central base.

Another embodiments of an isolator, in accordance with the present invention have a hollow conical portion open at the conical base end and is of a concave shape toward the central base.

Additional embodiments of isolator, in accordance with the present invention have a hollow polygonal or polyhedral shaped portion open at one end with the open end of the polygon shape being either of an approximate convex form or an approximate concave form.

For example, other embodiments of the present invention have an isolator (or isolators) that has both a concave and a convex form that has the open ends of the conical or polygonal forms can either facing inward toward each other or outward away from each other.

The isolator walls with slits around the hollow areas can have increased deflection relative to a given load to soften the resistance of the deflecting portion of the isolator.

The geometric shape of the walls around the hollow and the wall thickness can be fine tuned, based on component suspension and vibration requirements. Durometer and overall thickness can also be fine tuned to meet isolator for harshness requirements. For example, a conical section isolator of relatively higher durometer elastic material could be used in military vehicles or heavier mobile systems that require more severe loading under more harsh conditions, whereas a conical section isolator made of relatively lower durometer elastic material could be used for suspension during shipment of more fragile assemblies that are package in larger container frames such as the box containers used for trains, plane or boat shipments.

In multiple stage isolator, deflected walls close the hollow area to form a uniform thickness wall with the remainder of the isolator, and thereby more or less evenly distribute the harsh load energies, leading to longer isolator and part durability.

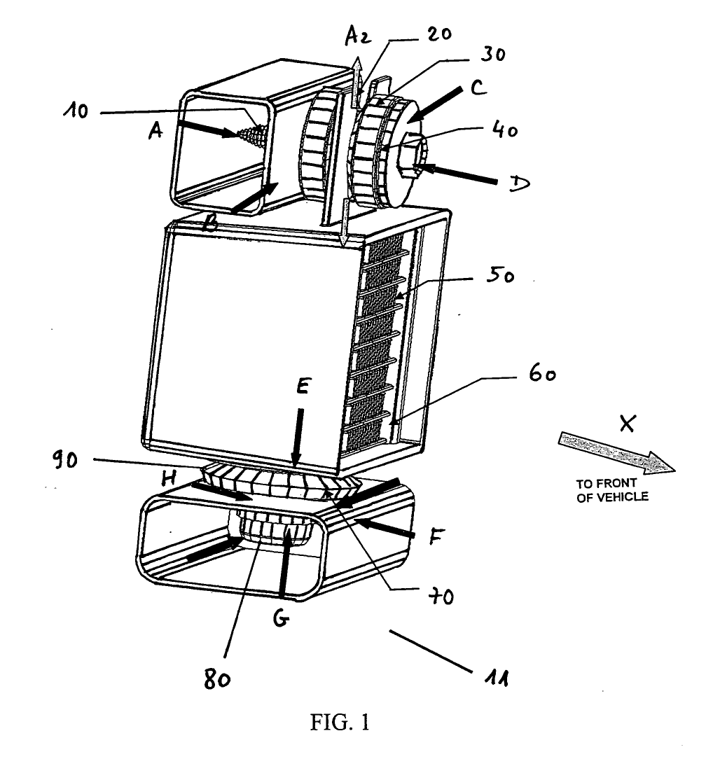

Referring to the FIGS. 1-16 are shown various aspects of the present invention, including aspects where the isolator forms part of an isolation system of at least two other components, each adjacent to one another.

The isolation system or ‘assembly’ of the another aspect of the present invention has contact surfaces of the isolator and between the contact surfaces of the heat exchanger and the opposing mounting frame illustrated.

The polygonal wall thickness allows for uniform wall fill at the distance between the contact surfaces when they are deflected to a flat position. The walls form an approximately uniform thickness so that the entire flattened isolator can distribute an approximately equal and uniform load to better receive high impact loads.

Referring to FIG. 1, round conical isolator (30) (cone shaped section), in free-state position, is shown with anti compressor sleeve (40) that limits over compression of isolator from vehicle mounting screw (10) Housing isolator slot (20) is illustrated with arrow A2 showing direction of housing upward movement restricted along the isolator (30).

Arrow A illustrates aft resistive load during vehicle acceleration, arrow B lateral acceleration load during right turns, for example. Arrow C shows component resistive load, arrow D represents rearward acceleration load during vehicle stopping.

Housing a frame assembly (11) of heat exchanger is oriented in the direction of arrow X representing to front of the vehicle. Housing mounting for heat exchanger or fan shroud (50) as well as vehicle lower mounting member (60) is shown.

Round pin conical isolator (70) with wiper ribs (144) shown in FIG. 14, (154) shown in FIG. 15 (114) shown in FIG. 11, are shown with conical section (80,) and cylindrical section (90) representing a stage vertical isolation and a stage later isolation mounting. Arrow E, represents downward jounce and gravity (restricted along lower isolator pin), and D, G, upward resistive load with elastic conical section (90) in between vehicle resistance to load during stopping and also upward rebond unrestricted movement along lower isolator pin, respectively.

FIG. 1 represents a heat exchanger and housing assembly mounted onto typical vehicle frame with dual stage isolators positioned (20) and (90) in between.

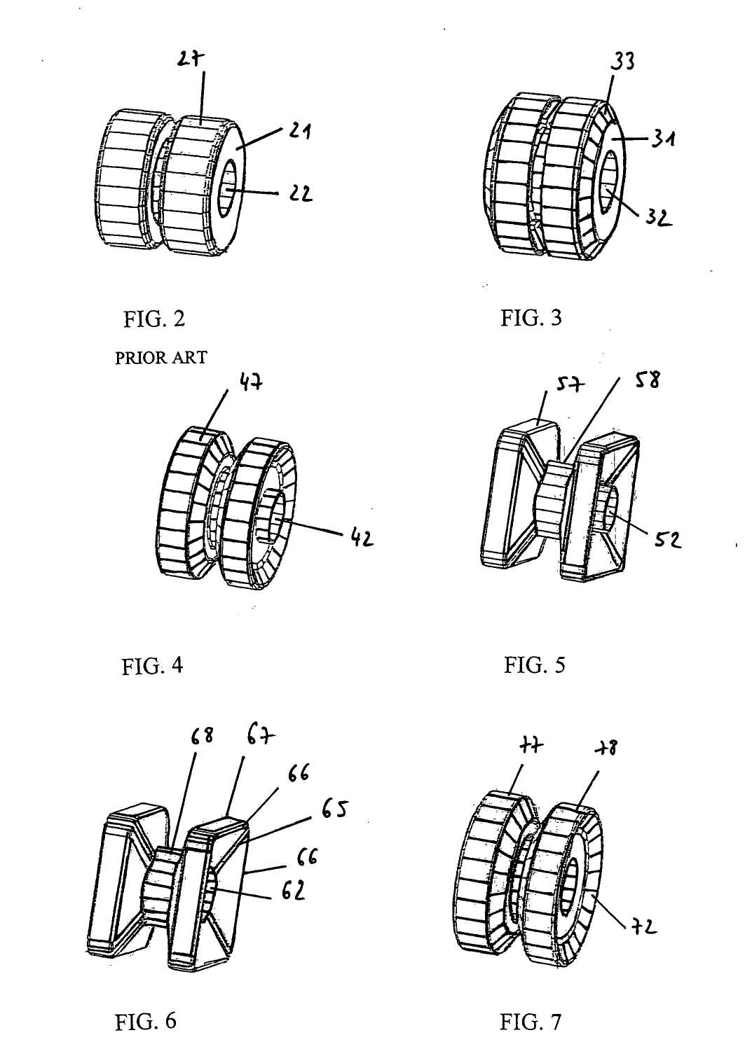

FIG. 2 represents prior art isolator having_a double cushion (24) with center reduced diametral area to receive a slotted plate mount.

FIG. 3 represents an aspect of the present invention having opposing concave conical sections (33).

FIG. 4 represents an aspect of the present invention having opposing convex conical sections (41) with a positive stop center sleeve (42).

FIG. 5 represents an aspect of the present invention having opposing convex (rectangular) pyramidal section (57) with a positive stop center sleeve (52) and wiper rib (58) and external wiper rib (58).

FIG. 6 represents an aspect of the present invention having opposing convex pyramidal sections (67) with external wiper rib (68) and slits (65) dividing deflecting areas into approximately equal portions or deflecting sections (66).

FIG. 7 represents an aspect of the present invention having opposing convex conical sections (77, 78).

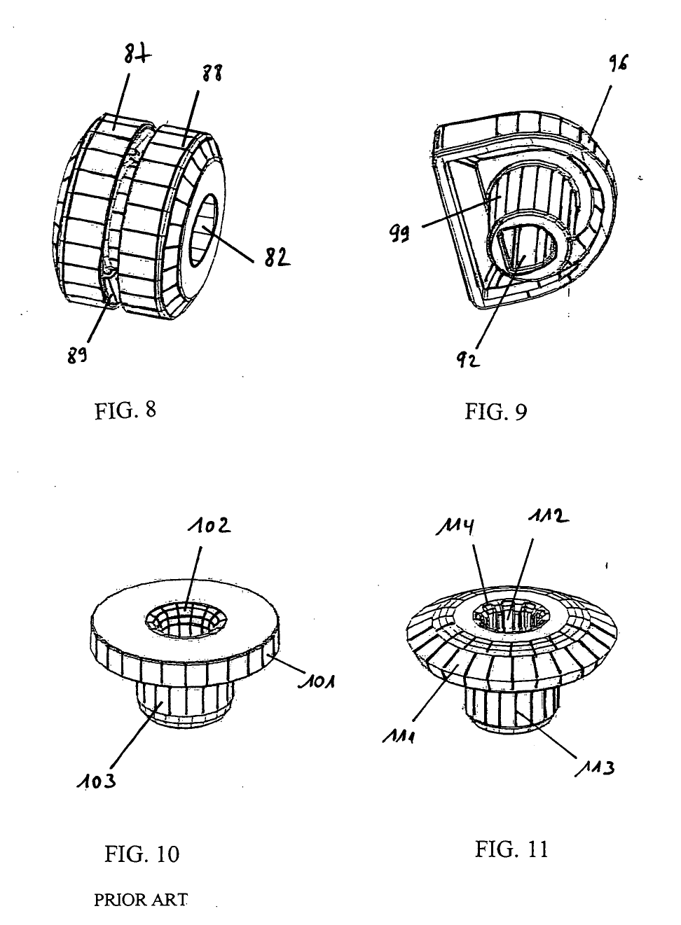

FIG. 8 represents an aspect of the present invention having opposing concave conical sections (88, 87) with radial wiper ribs (89).

FIG. 9 represents an aspect of the present invention having “D” shaped or circular and rectangular conical sections (96) with “D” pin center (92) isolator section (99).

FIG. 10 represents a prior art isolator having a flat round seat (101) with a pin hole (102) down through cylindrical section (103).

FIG. 11 represents an aspect of the present invention having a convex conical section (111) connected to a cylindrical (113) section with center hole having wiper rib (114) and rib nesting pockets (112).

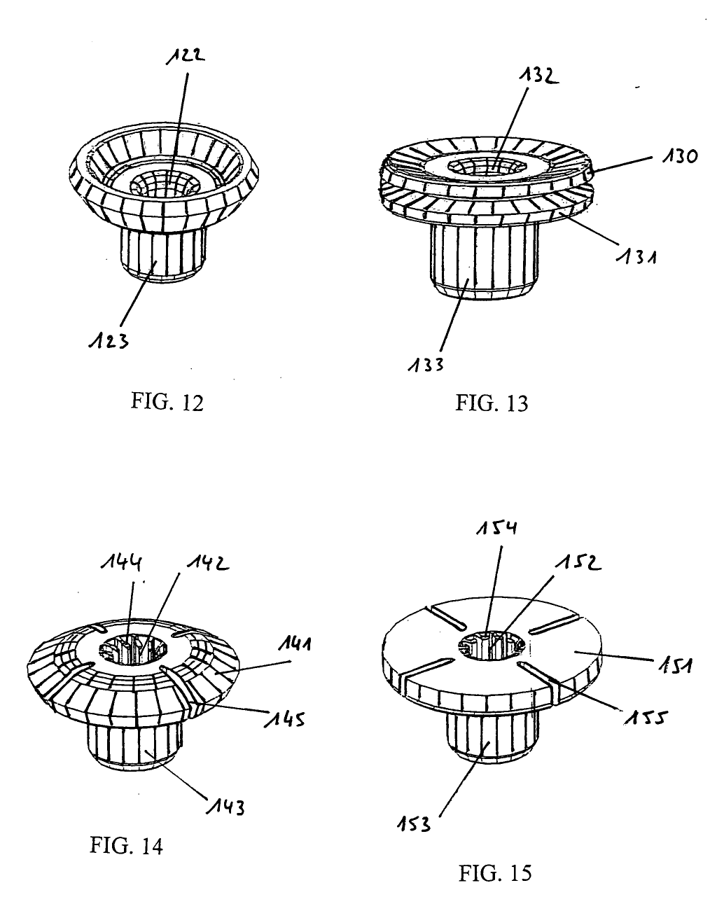

FIG. 12 represents an aspect of the present invention having a concave conical section (121) mounted to a connecting to a cylindrical section (123) with center pin hole (122).

FIG. 13 represents an aspect of the present invention having opposing convex conical sections (130, 131) having a center pin hole (132) through to an adjacent cylindrical section (133).

FIG. 14 represents an aspect of the present invention having a concave conical section with fingers sections (141) divided by slits (145) symmetrically spaced about the center with a center pin hole having wiper ribs (144) and nesting pockets (142).

FIG. 15 represents an aspect of the present invention having a conical section (151) fully deflected flat with wiper ribs and rib nesting pockets in center pin hole that is extending through an adjacent cylindrical section (153).

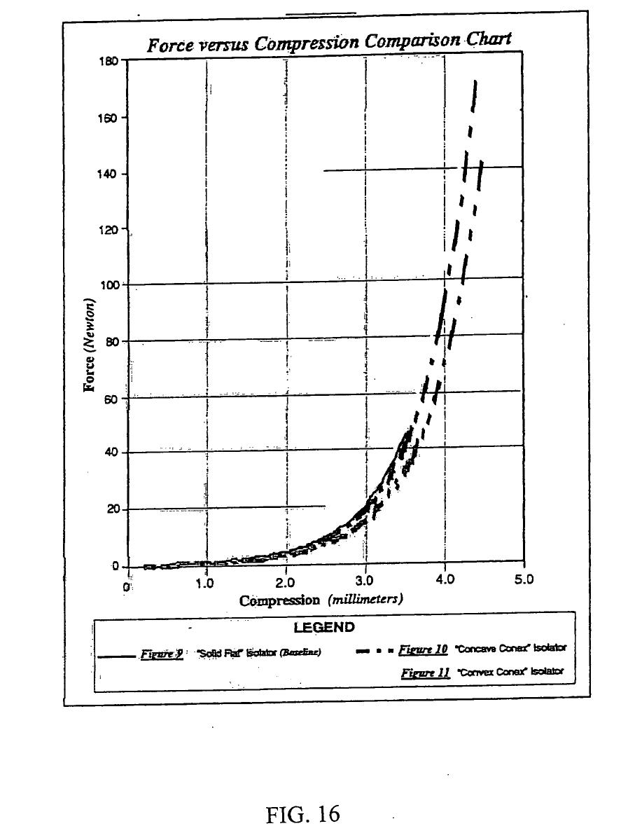

FIG. 16 compares force versus compression of various aspects of the present invention, having solid flat, round tubular, concave and convex, conic isolators. In general, convex means having an outward curved conical shape; concave means having an inward curved conical shape; and conics means being conical or cone shaped.

The isolator walls at the area of the hollow portions accept the initial inertial loading during higher frequency lighter load inertias by deflecting the elastic walls around the hollow area as shown in Comparison Chart FIG. 16. This chart shows increased deflection per load with different geometric shape change from solid flat shape. The fully deflected hollow area walls along with the remainder of the isolator wall portions are to approximate a uniform thickness wall to accept lower frequency higher inertial loads and distribute them with approximate uniformity through the isolator between the opposing heat exchanger assembly and mounting frame contact areas. The mounting frame can be described as a vehicle frame component, and engine drive train component, or another heat exchanger assembly component.

Another aspect of the present invention is illustrated in the Figures. An isolator is used to maintain position space between the contact surface and the isolator main wall is to provide non-perpendicular external wiper ribs to maintain the static position of the heat exchanger while deflect under light loading (up to and including nesting into a hollow cavity design to receive, at least partially, the volume of the deflecting rib. Ribs spaced around the perimeter of the contact area, soften the position of the heat exchanger relative to the mounting frame contacting surfaces as shown in FIGS. 1, 5, 6, 11, 14 and 15. The wiper ribs tend to absorb noise vibration by maintaining separation off of the normal wall thickness of the isolator.

Referring to FIG. 9 is shown a compound shape of approximately conical sections formed of both conical and pyramidal shaped portions shaped together in transition from one to the other to eventual form, for example, a different shape such as the approximate “D” Shape as shown in FIG. 9. The shape of the contacting surface contour can be made non-parallel planes, as long as the deflecting wall deforms to a uniform thickness as the hollow portion is flattened out. For example, the isolator lower contact surface is contoured upward as it traverses the circular portion of the “D” Shaped area as shown in FIG. 11.

As stated above, an isolator with the hollow polygonal portion of conical shapes may have one or more slits running along at least a portion of the conical walls to allow more deflection for a given load. The slits preferably divide the deflecting conical wall portions into approximately equal segments to balance the deflection loads, but may also be randomly positioned to balance the deflection loads in an isolator that is not fully symmetric (see FIG. 9). The slits as shown in the Figures would allow the conical walls to more easily deflect by reducing the circumference tension within the conical wall area and change the load/distance deflection rate as well as allow further separation of load requirements from between the deflection and compression stages of the isolator.

Another aspect of the present invention provides for an isolator that maintains position space between components made of an elastic material, such as rubber, that is molded of a single durometer stiffness material. The isolator is formed such that a hollow portion is forced between the contact surfaces of the isolator and between the contact surfaces of the heat exchanger and the opposing mounting frame. The hollow portion adjacent walls are of a thickness such that when they are deflected to a flat position (approximately parallel to the contact surfaces of the heat exchanger and mounting frame walls), they form an approximately uniform thickness with the remainder of the isolator wall portions and the entire flattened isolator can demonstrate an approximate uniform load. The isolator walls at the area of the hollow portions accept initial inertial loading during higher frequency lighter load inertias. The fully deflected hollow area walls along with the remainder of the isolator wall portions are to approximate a uniform thickness wall to accept lower frequency higher inertial loads and distribute them with approximate uniformity through the isolator between the opposing heat exchanger assembly and mounting frame contact areas. The mounting frame can be described as a vehicle frame component, an engine drive train component, or another heat exchanger assembly component.

Other aspects of the present invention are shown in FIGS. 6 and 15. An isolator with a conic or pyramid wall portions, has split polygon walls of approximately equal sections that increase the deflection stage travel capability relative to a given load. The elastic tension around the periphery of the open ended polygon structure is thereby reduced.

In various aspects of the present invention, an isolator and heat exchanger assembly exists having at least one first part or component that is a heat exchanger or portion of a heat exchanger and at least one second part or component that is a part or component of, or a portion of a part or component of, a motor vehicle, such as a mounting frame or portion of a mounting frame of an automotive vehicle. Preferably, in an isolator and component assembly, the component contact surface is adjacent to the at least one wall.

Unless stated otherwise, dimensions and geometries of the various structures depicted herein are not intended to be restrictive of the invention, and other dimensions or geometries are possible. Plural structural components can be provided by a single integrated structure. Alternatively, a single integrated structure might be divided into separate plural components. In addition, while a feature of the present invention may have been described in the context of only one of the illustrated embodiments, such feature may be combined with one or more other features of other embodiments, for any given application. It will also be appreciated from the above that the fabrication of the unique structures herein and the operation thereof also constitute methods in accordance with the present invention.

The preferred embodiment of the present invention has been disclosed. A person of ordinary skill in the art would realize however, that certain modifications would come within the teachings of this invention. Therefore, the following claims should be studied to determine the true scope and content of the invention.

What is claimed is:

1. An isolator of a generally uniform stiffness for use between parts or components wherein the isolator is made of a single durometer material and has at least one conical shaped cross section.

2. An isolator as in claim 1, wherein the isolator comprises at least two portions.

3. An isolator, as in claim 2, wherein at least one portion is a compression portion and wherein at least one portion is a deflection portion.

4. An isolator as in claim 3, further comprising at least one hollow portion.

5. An isolator as in claim 4, wherein the deflection portion is at least partially deflected into the at least one hollow at low inertial load conditions.

6. An isolator as in claim 5, further comprising at least one non-perpendicular rib.

7. An isolator as in claim 6, wherein the at least one rib, in compression, nests completely in the hollow.

8. An isolator, as in claim 7, wherein there are at least two ribs.

9. An isolator as in claim 5, wherein the isolator wall surrounding the at least one hollow wall forms an approximate conical shaped cross section of approximate uniform thickness.

10. An isolator as in claim 9, wherein the conical shaped cross section has an open base portion.

11. An isolator as in claim 5, wherein the isolator walls around the hollow of the at least on hollow portion, have at least one slit or aperture that divides the walls around the hollow area into symmetrical sections.

12. An isolator as in claim 6, wherein the isolator walls have an internal nesting cavity and, wherein at least one of the external walls of the isolator receives contact from adjacent component contact areas such that the at least one wiper rib that is non-perpendicular to the tangent contact surfaces that is deflected, upon load, into the nesting cavity.

13. An isolator as in claim 12, wherein that approximate the wiper rib volume, is such that it completely enters the nesting cavity to form an approximate uniform contact surface.

14. An isolator as in claim 13 such that the wiper rib deflects inward toward the normal isolator surface to form an approximate uniform contact surface.

15. An isolator as in claim 4, wherein the wall surrounding the at least one hollow of the hollow portion, forms a shape similar to a pyramidal or polygon and wherein the wall has flat portions.

16. An isolator as in claim 15, wherein the flat wall portions around the hollow are deflected upon load to displace the hollow portion between opposing contact surfaces until the wall thickness becomes an approximate uniform wall thickness.

17. An isolator as in claim 5, wherein the walls around the hollow area have at least one slit aperture to divide the walls around the hollow area into symmetrical sections.

18. An isolator and heat exchanger assembly, having an isolator as in claim 9, wherein at least one first part or component is a heat exchanger or portion of a heat exchanger and at least one second part or component is a part or component of, or a portion of a part or component of, a motor vehicle.

19. An isolator and heat exchanger assembly, as in claim 18, wherein the at least one second part is a mounting frame or portion of a mounting frame of an automotive vehicle.

20. An isolator and component assembly comprising:
a. an isolator having at least one wall which is conical in shape when seen in cross section;
b. at least one hollow within at least part of the at least one wall;
c. a first component having a component contact surface facing an isolator wall;
d. a second component having a component contact surface facing an isolator wall;
wherein the isolator is made of a single durometer material of generally uniform stiffness, the isolator is located between the first and second components and wherein the isolator has at least one wall in alignment with its respective component contact surface.

21. An isolator and component assembly, as in claim 20, wherein the conical shaped cross section has at least one slit.

22. An isolator and component assembly, as in claim 21, wherein the wall has at least one rib.

23. An isolator and component assembly, as in claim 22, wherein the isolator wall in alignment with it respective component contact surface, has least one rib.

24. An isolator and component assembly, as in claim 23, and wherein the at least one rib is a wiper rib, and wherein the wiper rib is non-perpendicular to a tangent drawn at the point of contact of the component contact surface and the isolator wall.

25. A heat exchanger assembly comprising:
a heat exchanger;
an isolator and component assembly; and
at least one isolator mount,
wherein the isolator and component assembly comprises at least one isolator having a conical cross section and a hollow.

26. A heat exchanger assembly as in claim 25, further comprising a slit in the conical cross section.

27. A heat exchanger assembly as in claim 26, further comprising a rib on the conical cross section.

28. A heat exchanger assembly, as in claim 27, wherein the wiper rib is a non-perpendicular wiper rib.

29. A heat exchanger assembly as in claim 25, having at least two isolators.

30. A heat exchanger assembly as in claim 27, having at least two isolators mounts.
